(19) United States
(12) Patent Application Publication
(10) Pub. No.: US 2007/0038453 A1
(43) Pub. Date: Feb. 15, 2007

(54) Speech recognition system

(75) Inventors: Takanori Yamamoto, Kanagawa (JP); Hiroshi Kanazawa, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Minato-Ku (JP)

(21) Appl. No.: 11/500,335

(22) Filed: Aug. 8, 2006

(30) Foreign Application Priority Data
Aug. 9, 2005 (JP) 2005-231140

(51) Int. Cl. G10L 15/18

(52) U.S. Cl. 704/257

(57) ABSTRACT

When an input vocabulary is stored in advance in a pronunciation dictionary unit, a phoneme sequence correlated with the input vocabulary is acquired from the pronunciation dictionary unit and a dictionary code indicating that the acquisition source is the pronunciation dictionary unit is generated. When the input vocabulary is not stored in advance in the pronunciation dictionary unit, a phoneme sequence of the input vocabulary is generated by a pronunciation generation unit and a generation code indicating that the acquisition source is the pronunciation generation unit is generated. Then, a recognition grammar model in which the phoneme sequence of the input vocabulary is correlated with the dictionary code or the generation code of the input vocabulary is stored and a recognition parameter is generated.

### RELATED APPLICATION(S)

The present disclosure relates to the subject matter contained in Japanese Patent Application No. 2005-231140 filed on Aug. 9, 2006, which is incorporated herein by reference in its entirety.

### FIELD

The present invention relates to a speech recognition system, a speech recognition device, a recognition grammar model generation device, and a method for generating a recognition grammar model used in a speech recognition device.

### BACKGROUND

As a recognition grammar model generation tool, there is known a tool called “The Lexicon Toolkit”. The Lexicon Toolkit adds the spelling of a vocabulary and a phonological sequence indicating the pronunciation of the vocabulary to a recognition grammar model, by inputting the spelling of the vocabulary to an “orthographic field”, pushing a “convert button”, acquiring and inputting the phonological sequence indicating the pronunciation of the vocabulary to a “phonetic expressions field”, and pushing an “OK button”.

The details of the Lexicon Toolkit are described in the following document:
(PCMM ASR1600 for Windows (registered trademark) V3 Software Development Kit Version 3.5 Development Tools User's Guide) THE LEXICON TOOLKIT, Menu commands, Context menu, add, Lernout & Hauspie Speech Products, July 2000

At the time of addition, the pronunciation of the vocabulary is first searched out from a dictionary in which the spelling of vocabulary is correlated with the phonological sequences indicating the pronunciation of the vocabulary. When the pronunciation of the vocabulary can be acquired from the dictionary, the acquired pronunciation is input to the phonetic expression field.

When the pronunciation of the vocabulary is not acquired from the dictionary, a phonetic sequence indicating the pronunciation of the vocabulary is generated by the use of a spelling-phonological sequence conversion rule and the generated phonological sequence indicating the pronunciation of the vocabulary is input to the phonetic expression field.

The phonological sequence is expressed by a series of characters, such as “#”, “'”, “t”, “E”, and “s”, which is defined for each of phonemes.

For example, when a vocabulary “test” is input to the orthographic field, a phonological sequence “#'tEst#” is input to the phonetic expression field by pushing the convert button.

However, the Lexicon Toolkit acquires a phonological sequence indicating the pronunciation of a vocabulary from the spelling of the word, but does not have a function of providing whether the pronunciation of the vocabulary has been acquired from the dictionary or has been generated by the use of a spelling-phonological sequence conversion rule.

### SUMMARY

According to a first aspect of the invention, there is provided a speech recognition system including: an A/D converter that generates voice data by quantizing a voice signal that is obtained by recording a speech; a feature generation unit that generates a feature parameter of the voice data based on the voice data; an acoustic model storage unit that stores acoustic models for each of phonemes as an acoustic feature parameter, the phonemes being included in a language spoken in the speech; a matching unit that expresses pronunciations of a plurality of vocabularies spoken in the speech by time series of phonemes as phoneme sequence, calculates a degree of similarity of the phoneme sequence to the feature parameter as a score, and outputs a vocabulary corresponding to the phoneme sequence having the highest score as the vocabulary corresponding to the voice signal; a pronunciation dictionary unit that stores the vocabularies being correlated with the phoneme sequences; a pronunciation generation unit that generates the phoneme sequence of the vocabulary input from the matching unit; a recognition grammar model generation unit that, when the input vocabulary is stored in the pronunciation dictionary unit, acquires the phoneme sequence correlated with the vocabulary from the pronunciation dictionary unit and generates a dictionary code indicating that the acquisition source is the pronunciation dictionary unit, and when the input vocabulary is not stored in the pronunciation dictionary unit, acquires the phoneme sequence correlated with the input vocabulary from the pronunciation generation unit and generates a generation code indicating that the acquisition source is the pronunciation generation unit; a recognition grammar model storage unit that stores a recognition grammar model in which the vocabulary input from the matching unit, the phoneme sequence corresponding to the input vocabulary, and one of the dictionary code and the generation code of the input vocabulary, are correlated with each other; and a parameter generation unit that generates a recognition parameter.

According to a second aspect of the invention, there is provided a recognition grammar model generation device for outputting a recognition grammar model to a speech recognition device. The recognition grammar model generation device includes: a pronunciation dictionary unit that stores vocabularies being correlated with phoneme sequences, the phoneme sequences expressing pronunciations of a plurality of vocabularies spoken in a speech by time series of phonemes, the speech being subjected to a speech recognition in the speech recognition device; a pronunciation generation unit that generates the phoneme sequence of the vocabulary input from the speech recognition device; a recognition grammar model generation unit that, when the input vocabulary is stored in the pronunciation dictionary unit, acquires the phoneme sequence correlated with the vocabulary from the pronunciation dictionary unit and generates a dictionary code indicating that the acquisition source is the pronunciation dictionary unit, and when the input vocabulary is not stored in the pronunciation dictionary unit, acquires the phoneme sequence correlated with the input vocabulary from the pronunciation generation unit and generates a generation code indicating that the acquisition source is the pronunciation generation unit; a recognition grammar model storage unit that stores a recognition grammar model in which the vocabulary input from the speech recognition device, the phoneme sequence corresponding to the input vocabulary, and one of the dictionary code and the generation code of the input vocabulary, are correlated with each other; and a parameter generation unit that generates a recognition parameter.

According to a third aspect of the invention, there is provided a method for generating a recognition grammar model used in a speech recognition device. The method includes: storing in a pronunciation dictionary unit vocabularies being correlated with phoneme sequences, the phoneme sequences expressing pronunciations of a plurality of vocabularies spoken in a speech by time series of phonemes, the speech being subjected to a speech recognition in the speech recognition device; generating by a pronunciation generation unit the phoneme sequence of the vocabulary input from the speech recognition device; acquiring the phoneme sequence correlated with the vocabulary from the pronunciation dictionary unit and generating a dictionary code indicating that the acquisition source is the pronunciation dictionary unit, when the input vocabulary is stored in the pronunciation dictionary unit; acquiring the phoneme sequence correlated with the input vocabulary from the pronunciation generation unit and generating a generation code indicating that the acquisition source is the pronunciation generation unit, when the input vocabulary is not stored in the pronunciation dictionary unit; storing a recognition grammar model in which the vocabulary input from the speech recognition device, the phoneme sequence corresponding to the input vocabulary, and one of the dictionary code and the generation code of the input vocabulary, are correlated with each other; and generating a recognition parameter.

According to a fourth aspect of the invention, there is provided a speech recognition device including: an A/D converter that generates voice data by quantizing a voice signal that is obtained by recording a speech; a feature generation unit that generates a feature parameter of the voice data based on the voice data; an acoustic model storage unit that stores acoustic models for each of phonemes as an acoustic feature parameter, the phonemes being included in a language spoken in the speech; and a matching unit that expresses pronunciations of a plurality of vocabularies spoken in the speech by time series of phonemes as phoneme sequence, calculates a degree of similarity of the phoneme sequence to the feature parameter as a score, and outputs a vocabulary corresponding to the phoneme sequence having the highest score as the vocabulary corresponding to the voice signal.

### BRIEF DESCRIPTION OF THE DRAWINGS

In the accompanying drawings:

FIG. 1 is a diagram illustrating a configuration of a speech recognition system including a speech recognition device and a recognition grammar model generation device according to an embodiment of the invention;

FIG. 2 is a diagram illustrating a configuration of the recognition grammar model generation device according to the embodiment;

FIG. 3 is a diagram illustrating a configuration of the speech recognition device according to the embodiment;

FIG. 4 is a flowchart illustrating a recognition grammar model generation method according to the embodiment;

FIG. 5 is a flowchart illustrating a speech recognition method according to the embodiment;

FIG. 6 is a flowchart illustrating a speech recognition method using the speech recognition system;

FIG. 7 is flowchart (1) illustrating a parameter control step in the recognition grammar model generation method and the speech recognition method according to the embodiment;

FIG. 8 illustrates examples of a vocabulary input to the recognition grammar model generation unit shown in FIG. 1;

FIG. 9 is a diagram illustrating a data structure (1) of a database storing the examples of the vocabulary added to the recognition grammar model storage unit shown in FIG. 1;

FIG. 10 is a diagram illustrating a data structure (2) of a database storing the examples of the words added to the recognition grammar model storage unit shown in FIG. 1;

FIG. 11 is a flowchart (2) illustrating the parameter control step in the recognition grammar model generation method and the speech recognition method according to the embodiment;

FIG. 12 is a diagram illustrating a data structure (3) of a database storing the examples of the words added to the recognition grammar model storage unit shown in FIG. 1 ;

FIG. 13 is a diagram illustrating a data structure (4) of a database storing the examples of the words added to the recognition grammar model storage unit shown in FIG. 1;

FIG. 14 is a flowchart (3) illustrating the parameter control step in the recognition grammar model generation method and the speech recognition method according to the embodiment;

FIG. 15 is a diagram illustrating a data structure (5) of a database storing the examples of the words added to the recognition grammar model storage unit shown in FIG. 1;

FIG. 16 is a diagram illustrating a data structure (6) of a database storing the examples of the words added to the recognition grammar model storage unit shown in FIG. 1; and

FIG. 17 is a flowchart (4) illustrating the parameter control step in the recognition grammar model generation method and the speech recognition method according to the embodiment.

### DETAILED DESCRIPTION OF THE EMBODIMENT(S)

Hereinafter, embodiments of the present invention will be described with reference to the drawings. The drawings which are referred to by the embodiments of the invention are only schematic, but the invention is not limited to the drawings. In the drawings, elements equal or similar to each other are denoted by reference numerals equal or similar to each other. It should be noted that the drawings are mimetic and are thus different from the actual ones.

First Embodiment

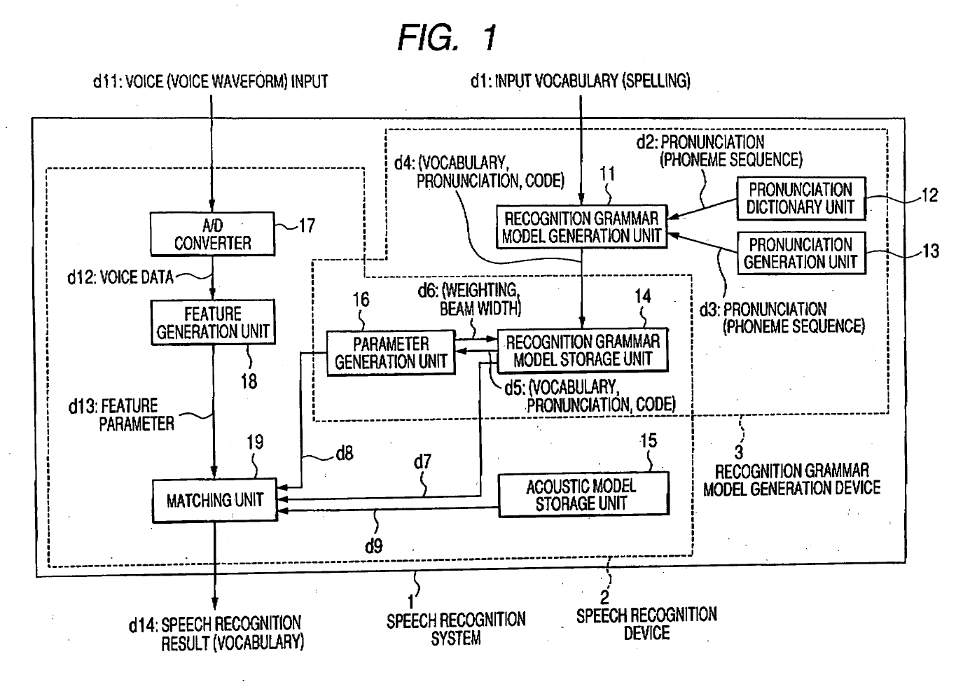

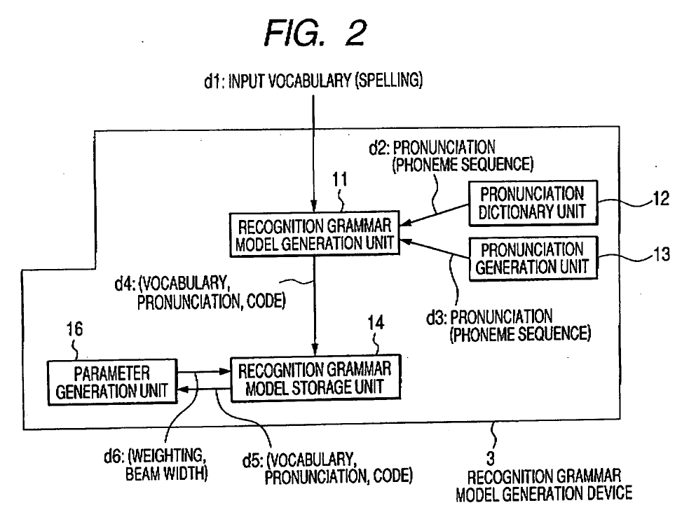

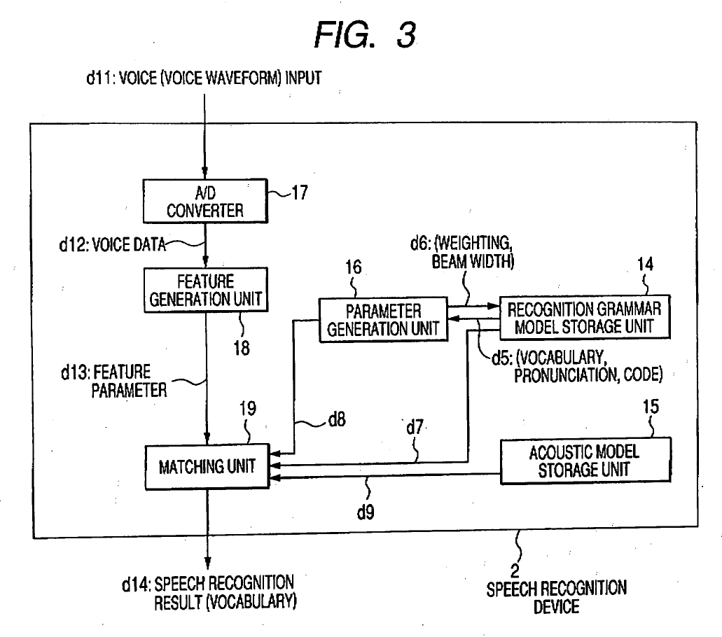

As shown in FIG. 1, a speech recognition system 1 according to a first embodiment includes a speech recognition device 2 and a recognition grammar model generation device 3. As shown in FIG. 2, the recognition grammar model generation device 3 includes a recognition grammar model generation unit 11, a pronunciation dictionary unit 12, a pronunciation generation unit 13, a recognition grammar model storage unit 14, and a parameter generation unit 16. As shown in FIG. 3, the speech recognition device 2 includes a recognition grammar model storage unit 14, an acoustic model storage unit 15, a parameter generation unit 16, an analog-to-digital (A/D) conversion unit 17, a feature generation unit 18, and a matching unit 19. When the speech recognition device 2 and the recognition grammar model generation device 3 are separated from each other, the recognition grammar model storage unit 14 is necessarily disposed in each of the speech recognition device 2 and the recognition grammar model generation device 3. The parameter generation unit 16 can be disposed in one of the speech recognition device 2 and the recognition grammar model generation device 3. The constituent units of the speech recognition system 1, the speech recognition device 2, and the recognition grammar model generation device 3 will be described.

The pronunciation dictionary unit 12 correlates and stores the pronunciations of a plurality of vocabularies with a plurality of phoneme sequences expressed by time sequences of phonemes.

The pronunciation generation unit 13 generates a phoneme sequence of a vocabulary input to the pronunciation generation unit 13.

A vocabulary (spelling) d1 is input to the recognition grammar model generation unit 11. When the input vocabulary d1 is stored in the pronunciation dictionary unit 12, the recognition grammar model generation unit 11 acquires a phoneme sequence d2 correlated with the input vocabulary d1 from the pronunciation dictionary unit 12. When the input vocabulary d1 is stored in the pronunciation dictionary unit 12, the recognition grammar model generation unit 11 generates a dictionary code indicating that the acquisition source is the pronunciation dictionary unit 12. On the other hand, when the input vocabulary d1 is not stored in the pronunciation unit 12, the recognition grammar model generation unit 11 acquires a phoneme sequence d3 of the input vocabulary from the pronunciation generation unit 13. When the input vocabulary d1 is not stored in the pronunciation dictionary unit 12, the recognition grammar model generation unit 11 generates a generation code indicating that the acquisition source is the pronunciation generation unit 13. That is, when the pronunciation (phoneme sequence) d2 corresponding to the input vocabulary d1 is registered in the pronunciation dictionary unit 12, the recognition grammar model generation unit 11 acquires the pronunciation (phoneme sequence) d2 corresponding to the input vocabulary d1. The recognition grammar model generation unit 11 correlates the pronunciation (phoneme sequence d2, the input vocabulary d1, and the dictionary code indicating that the pronunciation is acquired from the pronunciation dictionary unit 12 with each other and additionally stores them in the recognition grammar model storage unit 14. When the pronunciation corresponding to the input vocabulary d1 is not registered in the pronunciation dictionary unit 12, the recognition grammar model generation unit 11 acquires the pronunciation d3 corresponding to the input vocabulary d1 from the pronunciation generation unit 13. The recognition grammar model generation unit 11 correlates the pronunciation d3, the input vocabulary d1, and the generation code indicating that the pronunciation is acquired from the pronunciation generation unit 13 with each other and additionally stores them in the recognition grammar model storage unit 14.

The recognition grammar model storage unit 14 stores a recognition grammar model in which the input vocabulary d1, the phoneme sequence d2 or d3 corresponding to the input vocabulary d1, and the dictionary code or the generation code of the input vocabulary d1 are correlated with each other.

The parameter generation unit 16 generates recognition parameters d6 and d8 which make the speech recognition device 2 easier to extract an acoustic model of a vocabulary correlated with the generation code than an acoustic model of a vocabulary correlated with the dictionary code.

The parameter generation unit 16 controls the recognition parameters d6 and d8. That is, the parameter generation unit 16 receives a word, the pronunciation of the word, and a code (hereinafter, properly referred to as a pronunciation acquisition code) d5 indicating whether the pronunciation of the vocabulary is acquired from the pronunciation dictionary unit 12 (dictionary code) or from the pronunciation generation unit 13 (generation code) from the recognition grammar model storage unit 14, generates the recognition parameters d6 and d8 on the basis of the pronunciation acquisition code so as to improve performances such as the recognition rate, the amount of calculation, and the amount of used memory, and then stores the recognition parameters in the recognition grammar model storage unit 14 or outputs the recognition parameters to the matching unit 19.

The A/D converter 17 generates voice data d12 obtained by quantizing an input voice signal d11. That is, a waveform of analog voice is input to the A/D converter 17. The A/D converter 17 converts the voice signal into the voice data d12 as a digital signal by sampling and quantizing the voice signal as an analog signal. The voice data d12 are input to the feature generation unit 18.

The feature generation unit 18 generates a feature parameter d13 of the voice data from the voice data d12. That is, the feature generation unit 18 performs a Mel Frequency Cepstrum Coefficient (MFCC) analysis to the voice data d12 input to the feature generation unit 18 in the unit of frame and inputs the analysis result as the feature parameter (feature vector d13) to the matching unit 19. The feature generation unit 18 may extract a linear prediction coefficient, acepstrumcoefficient, aspecific frequency band power (output of filter bank), and the like as the feature parameter d13, in addition to the MFCC.

The acoustic model storage unit 15 stores acoustic feature parameters d9 of phonemes in the language constituting the voice signal d11.

The acoustic model storage unit 15 stores an acoustic model indicating acoustic features of the pronunciations in the language of the voice to be recognized.

The matching unit 19 generates the acoustic models of a plurality of vocabularies in which the feature parameters d9 of phonemes are arranged in the order of the phonemes of the phoneme sequences d7 of a plurality of vocabularies. The matching unit 19 calculates the accumulated value obtained by accumulating the appearance probability of the feature parameter 13 of the voice data d12 and a plurality of scores from the recognition parameter in the acoustic models of the vocabularies. The matching unit 19 extracts the acoustic model of the vocabulary having the highest score. The matching unit 19 outputs the vocabulary d14 corresponding to the extracted acoustic model of the vocabulary as the vocabulary corresponding to the voice signal d11. The matching unit 19 performs speech recognition to the input voice signal d11 by performing, for example, a Hidden Markov Model (HMM) method with reference to the recognition grammar model storage unit 14, the acoustic model storage unit 15, and the parameter generation unit 16 as needed by the use of the feature parameter d13 from the feature generation unit 18.

The matching unit 19 constitutes an acoustic model of a vocabulary by correlating the acoustic feature parameter d9 of phonemes stored in the acoustic model storage unit 15 with the pronunciation d7 of the vocabulary registered in the recognition grammar model storage unit 14. The matching unit 19 recognizes the input voice signal d11 by performing the HMM method on the basis of the feature parameter d13 by the use of the acoustic model of the vocabulary and the recognition parameter d8 used for the speech recognition process. That is, the matching unit 19 operates with reference to the recognition parameter d8, accumulates the appearance probability of the time-series feature parameter d13 output from the feature generation unit 18 for the acoustic model of the word, sets the accumulated value as the score (likelihood), detects the acoustic model of the vocabulary having the highest score, and outputs the vocabulary corresponding to the detected acoustic model as a speech recognition result.

The speech recognition system 1 may be a computer and the speech recognition system 1 may be embodied by making a computer to execute the procedure registered in a program. The speech recognition device 2 may be a computer and the speech recognition device 2 may be embodied by making a computer to execute the procedure registered in a program. The recognition grammar model generation device 3 may be a computer and the recognition grammar model generation device 3 may be embodied by making a computer to execute the procedure registered in a program.

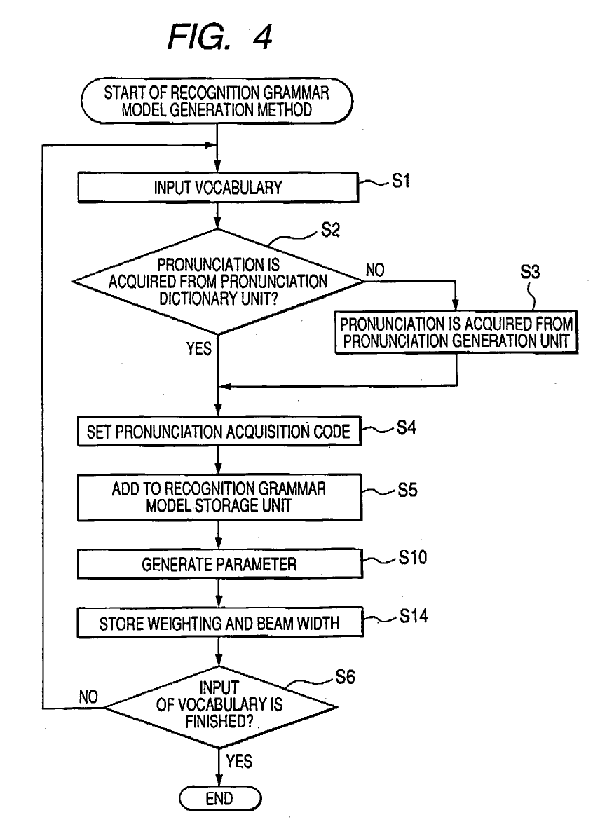

A recognition grammar model generation method executed by the recognition grammar model generation device 3 shown in FIG. 2 will be described with reference to FIG. 4.

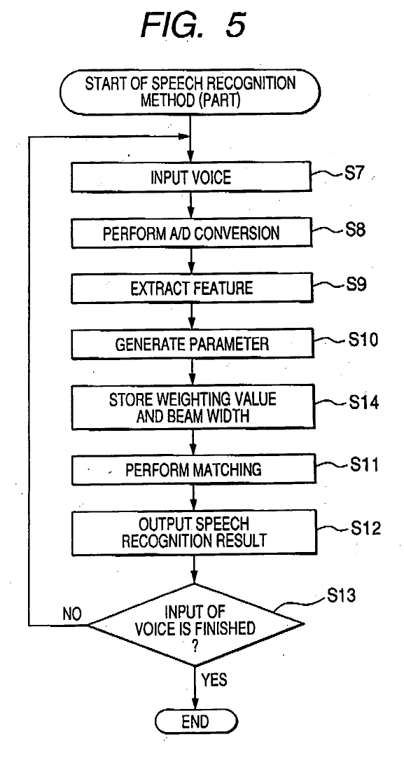

As shown in FIGS. 4 and 5, in the recognition grammar model generation method, first the recognition grammar model generation unit 11 receives a vocabulary d1 in step Si and then performs the process of step S2.

When the recognition grammar model generation unit 11 can acquire the pronunciation d2 corresponding to the vocabulary d1 from the pronunciation dictionary unit 12 in step S2, the process of step S4 is performed. When the recognition grammar model generation unit 11 cannot acquire the pronunciation d2 corresponding to the vocabulary d1 from the pronunciation dictionary unit 12, the process of step S3 is performed.

In step S3, the recognition grammar model generation unit 11 acquires the pronunciation d3 from the pronunciation generation unit 13, and then the process of step S4 is performed.

In step S4, the recognition grammar mode generation unit 11 correlates the pronunciation acquisition code with the vocabulary d1. Then, the process of step S5 is performed.

In step S5, the recognition grammar model generation unit 11 additionally stores the word, the pronunciation corresponding to the word, and the pronunciation acquisition code d4 in the recognition grammar model storage unit 14. Then, the process of step S10 is performed.

In step S10, the parameter generation unit 16 generates the recognition parameters d6 and d8 on the basis of the word, the pronunciation of the word, and the pronunciation acquisition code d5 stored in the recognition grammar model storage unit 11, and then the process of step S14 is performed.

In step S14, the recognition grammar model storage unit 14 correlates and stores the weighting value or the beam width of the recognition parameter d6 with the word, the pronunciation of the word, and the pronunciation acquisition code d5. Then, the process of step S6 is performed. In the entire speech recognition method shown in FIG. 4, it is not necessary to store the recognition parameter d6 of step S14, but in the recognition grammar model generation method, it is necessary to store the recognition parameter d6 of step S14. This is because the recognition grammar model generation method and the partially specified speech recognition method are temporally divided and performed.

The speech recognition method executed by the speech recognition device 2 shown in FIG. 3 will be described with reference to FIG. 5.

In step S6, the procedure is terminated when all the vocabularies d1 are input. When the vocabularies d1 are continuously input, the process of step S1 is performed again.

As shown in FIG. 5, in the partially specified speech recognition method, first, the voice signal d11 is input to the A/D converter 17 and then the process of step S8 is performed.

In step S8, the voice signal d11 as an analog signal is converted into the voice data d2 as a digital signal by the A/D converter 17, and then the process of step S9 is performed.

In step S9, the voice data d12 are analyzed by the feature generation unit 18 to extract the feature parameter d13, and then the process of step S10 is performed.

In step S10, the recognition parameters d6 and d8 are generated on the basis of the word, the pronunciation of the word, and the pronunciation acquisition code d5 stored in the recognition grammar model storage unit 11 by the parameter generation unit 16, and then the process of step S14 is performed.

In step S14, the weighting value or the beam width of the recognition parameter d6 are correlated with the word, the pronunciation of the word, and the pronunciation acquisition code d5 and stored in the recognition grammar model storage unit 14. Then, the process of step S11 is performed. The process of step S14 in the partially specified speech recognition method is not indispensable.

In step S11, a matching process of calculating a score on the basis of the recognition parameters d8 and d7 currently set is performed by the matching unit 19, and then the process of step S12 is performed.

In step S12, the speech recognition result is determined on the basis of the highest score among a plurality of scores calculated in the process of step S11 by the matching unit 19, the speech recognition result is output, and then the process of step S13 is performed.

When the voice signals d11 are all input in step S13, the procedure is finished to end the speech recognition method. When the voice signals d11 are continuously input, the process of step S7 is performed again.

It is sufficient that the generation of the recognition parameters d6 and d8 in step S10 shown in FIGS. 4 and 5 is disposed in any one of the partially specified speech recognition method shown in FIG. 5 and the recognition grammar model generation method shown in FIG. 4.

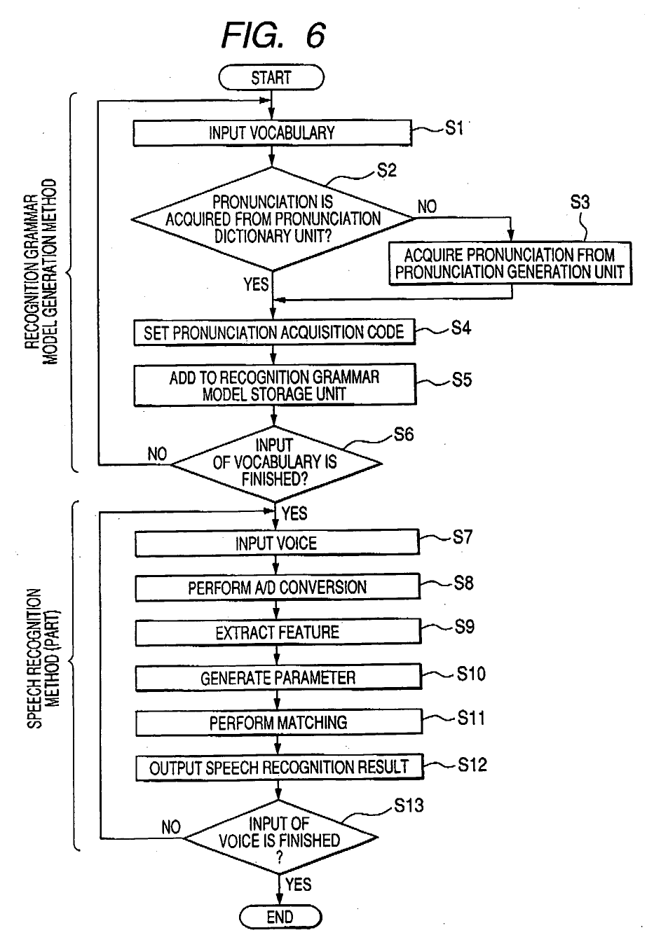

As shown in FIG. 6, the method having an influence on the entire speech recognition method according to the first embodiment includes the partially specified speech recognition method and the recognition grammar generation method. The entire speech recognition method is performed by the speech recognition system 1 shown in FIG. 1.

The speech recognition method can be embodied by a speech recognition program which can be sequentially executed by a computer. The speech recognition method can be performed by making the computer execute the speech recognition program. The recognition grammar model generation method can be embodied by a recognition grammar model generation program which can be sequentially executed by a computer. The recognition grammar model generation method can be performed by making the computer execute the recognition grammar model generation program.

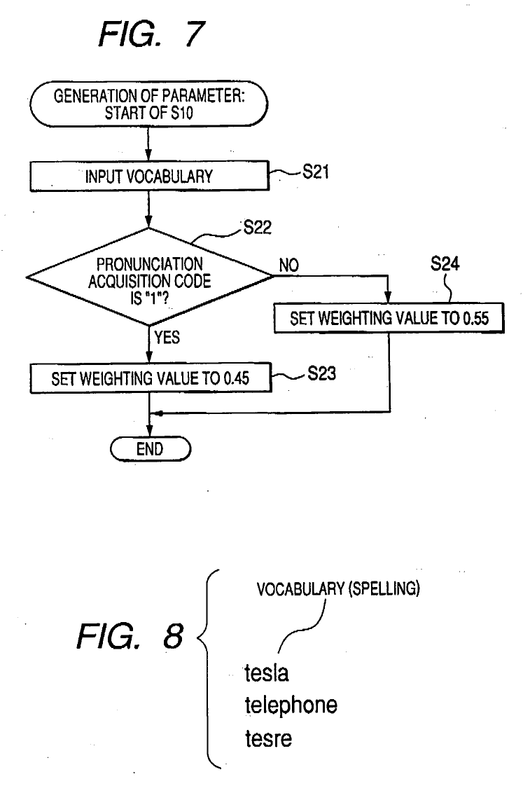

FIG. 7 is a flowchart illustrating a parameter generation process of the parameter generation unit 16 in step S10 shown in FIGS. 4 to 6 according to the first embodiment.

First, in step S21, the vocabulary d1 is input to the parameter generation unit 16 from the recognition grammar model storage unit 14 shown in FIG. 1, and then the process of step S22 is performed.

In step S22, it is determined by the parameter generation unit 16 whether the pronunciation acquisition code of the vocabulary d1 input from the recognition grammar model storage unit 14 is “1.” When the pronunciation acquisition code is “1”, the process of step S23 is performed, and when the pronunciation acquisition code is not “1”, the process of step S24 is performed. Regarding the vocabulary d1 input from the recognition grammar model storage unit 14, the pronunciation acquisition code is a code expressing in a binary value whether the pronunciation d2 or d3 corresponding to the vocabulary (spelling) d1 is acquired from the pronunciation dictionary unit 12 or from the pronunciation generation unit 13. When the pronunciation d2 is acquired from the pronunciation dictionary unit 12, the recognition grammar model generation unit 11 sets the dictionary code of the pronunciation acquisition code to “1”, and when the pronunciation d3 is acquired from the pronunciation generation unit 13, the recognition grammar model generation unit 11 sets the generation code of the pronunciation acquisition code to “0.”

In step S23, the parameter generation unit 16 correlates the vocabulary d1 with a weighting value of “0.45”, and then the parameter generation process of step S10 is terminated.

In step S24, the parameter generation unit 16 correlates the vocabulary d1 with a weighting value of “0.55”, and then the parameter generation process of step S10 is terminated. The weighting values “0.45” and “0.55” correlated with the vocabulary d1 are only examples, and other weighting values may be set. However, the weighting value set in the process of step S24 is larger than the weighting value set in the process of step S23.

As shown in FIG. 8, as examples of the vocabularies d1, the vocabularies d1 have the spellings such as “tesla”, “telephone”, and “tesre.” The vocabularies d1 input to the recognition grammar model generation unit 11 shown in FIG. 1 may be vocabularies d1 expressed in a sentence in which words are continuously arranged or vocabularies d1 obtained by expressing the entire vocabularies as a speech recognition subject in a network grammar in which words are connected through a network. The vocabularies d1 may be vocabularies d1 obtained by expressing the entire vocabularies as the speech recognition subject in a Context-Free Grammar (CFG) in which words are connected through logical symbols. That is, as for the vocabularies d1, the words constituting the vocabularies d1 are used as the vocabularies d1 input to the recognition grammar model generation unit 11 and the entire vocabularies can be processed by sequentially processing the words.

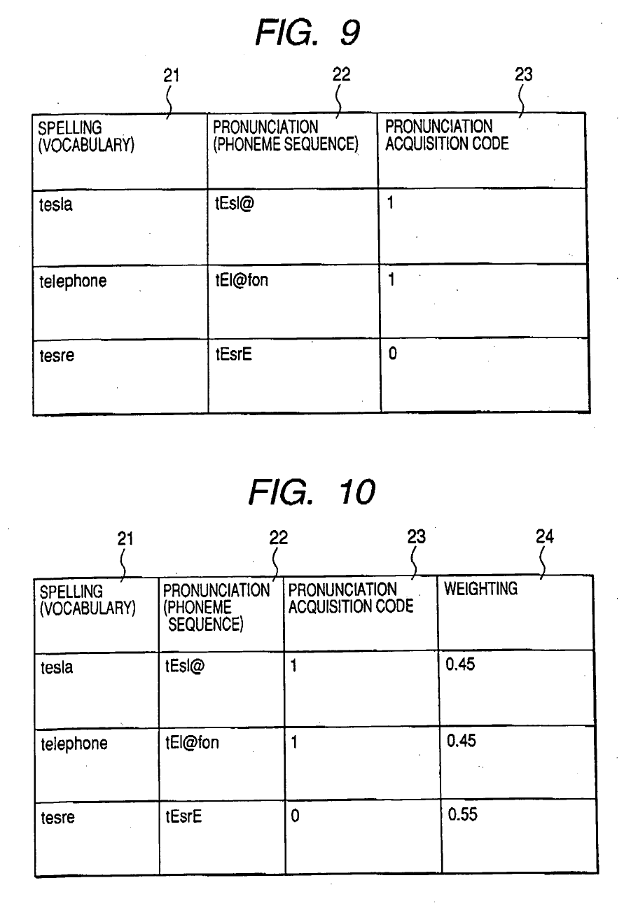

FIG. 9 illustrates the vocabularies, the phoneme sequences, and the pronunciation acquisition codes additionally stored in the recognition grammar model storage unit 14 shown in FIG. 1 according to the first embodiment. The recognition grammar model storage unit 14 has a spelling field 21, a phoneme sequence field 22, and a pronunciation acquisition code field 23. One record includes a vocabulary (spelling) “tesla”, a pronunciation (phoneme sequence) “tEsl@”, and a pronunciation acquisition code “1.” Another record includes a spelling “telephone”, a pronunciation “tEl@fon”, and a pronunciation acquisition code “1.” Another record includes a spelling “tesre”, a pronunciation “tEsrE”, and a pronunciation acquisition code “0.” The spellings “tesla”, “telephone”, and “terse” correspond to the vocabularies (spelling) of FIG. 8 input to the recognition grammar model generation unit 11 shown in FIG. 1. The pronunciations “tEsl@”, “tEl@fon”, and “tEsrE” are the pronunciations d2 and d3 corresponding to the spellings d1 and being acquired from the pronunciation dictionary unit 12 or the pronunciation generation unit 13 shown in FIG. 1, and are expressed by the continuous phonemes defining each sound. The pronunciation acquisition codes “1”, “1”, and “0” are codes expressing in binary whether the pronunciations d2 and d3 corresponding to the vocabulary (spelling) d1 are acquired from the pronunciation dictionary unit 12 or from the pronunciation generation unit 13. When the pronunciation d2 is acquired from the pronunciation dictionary unit 12, the pronunciation acquisition code is set to “1”, and when the pronunciation d3 is acquired from the pronunciation generation unit 13, the pronunciation acquisition code is set to “0.” From the above-mentioned description, it can be seen that the pronunciation “tEsl@” of the vocabulary “tesla” is acquired from the pronunciation dictionary unit 12. It can be also seen that the pronunciation “tEl@fon” of the spelling “telephone” is acquired from the pronunciation dictionary unit 12. It can be also seen that the pronunciation “tEsrE” of the spelling “terse” is acquired from the pronunciation generation unit 13.

FIG. 10 illustrates the recognition grammar model storage unit 14 in which the weighting value of the recognition parameter d6 generated from the parameter generation unit 16 shown in FIG. 1 is correlated and stored with the vocabulary d1, the phoneme sequence, and the pronunciation acquisition code. The recognition grammar model storage unit 14 includes a weighting field 24, in addition to the spelling field 21, the phoneme sequence field 22, and the pronunciation acquisition code field 23. A weighting value is correlated with a record having a spelling, a pronunciation, and a pronunciation acquisition code. The weighting value is generated and stored by processing the record including the spelling, the pronunciation, and the pronunciation acquisition code by the use of parameter generation process shown in FIG. 7.

The record including the spelling “tesla”, the pronunciation “tEsl@”, and the pronunciation acquisition code “1” is correlated with the weighting value “0.45.” The record including the spelling “telephone”, the pronunciation “tEl@fon”, and the pronunciation acquisition code “1” is correlated with the weighting value “0.45.” The record including the spelling “terse”, the pronunciation “tEsrE”, and the pronunciation acquisition code “0” is correlated with the weighting value “0.45.” The weighting value “0.55” of the record having the pronunciation acquisition code “0” is larger than the weighting value “0.45” of the record having the pronunciation acquisition code “1.”

The matching unit 19 operates so as to make it easy for the vocabulary having the larger weighting value to appear as a recognition result, and operates so as to make it difficult for the vocabulary having the smaller weighting value to appear as the recognition result. As for the feature parameters of voice data output from the feature generation unit 18 and arranged in time series with regard to acoustic models of vocabularies, the appearance probabilities of the acoustic models in which the feature parameters of phonemes are arranged in the order of phoneme sequences of the vocabularies are accumulated to calculate the accumulated values. A second score is obtained by multiplying the first score as the accumulated values by a first score. The acoustic model of the vocabulary having the highest second score is detected, and the vocabulary corresponding to the detected acoustic model is output as the speech recognition result. Accordingly, it is possible to make it easy or difficult for the vocabulary to appear as the recognition result on the basis of the weighting value of the vocabulary. On the contrary, any method may be employed, if it is not limited to the method of multiplying the first score by the weighting value but it operates so as to make it easy for a vocabulary correlated with the generation code to appear as the recognition result and to make it difficult for a vocabulary correlated with the dictionary code to appear as the recognition result, depending upon the pronunciation acquisition code.

The pronunciation d2 acquired from the pronunciation dictionary unit 12 is a pronunciation d2 registered in advance in the pronunciation dictionary unit 12, and the accuracy of the registered pronunciation d2 is reliable. The pronunciation d3 acquired from the pronunciation generation unit 13 is a pronunciation d3 generated in a pronunciation generation rule by the pronunciation generation unit 13, and the accuracy of the pronunciation d3 generated in the rule is lower than that of the pronunciation d2 registered in the pronunciation dictionary unit 12. That is, the pronunciation d3 acquired from the pronunciation generation unit 13 may be partially incorrect. An incorrect pronunciation correlated with a vocabulary may be registered in the recognition grammar model storage unit 14 and may be used in the matching process. By performing the matching process using the incorrect pronunciation, a correct recognition result may not be obtained though a talker correctly pronounces the corresponding vocabulary. In other words, the score of a different vocabulary, which has the pronunciation d2 acquired from the pronunciation dictionary unit 12 and similar to the correct pronunciation, is larger than the score of the desired vocabulary, which has the partially incorrect pronunciation d3 acquired from the pronunciation generation unit 13, thereby obtaining the different vocabulary as the recognition result.

Therefore, in the first embodiment, by setting the weighting value correlated with the vocabulary acquired from the pronunciation dictionary unit 12 to be smaller than the weighting value correlated with the vocabulary acquired from the pronunciation generation unit 13, the score of the different vocabulary having the pronunciation acquired from the pronunciation dictionary unit 12 and similar to the correct pronunciation is decreased and the score of the desired vocabulary having the partially incorrect pronunciation acquired from the pronunciation generation unit 13 is increased, thereby making it easy to acquire the desired vocabulary as the recognition result.

For example, it is assumed that a vocabulary having the spelling “terse”, the pronunciation “tEsrE”, and the pronunciation acquisition code “0” shown in FIG. 10 is registered in the recognition grammar model storage unit 14 and the correct pronunciation of the spelling “terse” is “tEslE.”

First, the pronunciation “tEslE” (hereinafter, the pronunciation is expressed by phoneme symbols) is subjected to the matching process without using the weighting value “0.55.” It is assumed that the vocabulary having the spelling “tesla”, the pronunciation “tEsl@”, and the pronunciation acquisition code “1” acquires a score of 1000. It is also assumed that the vocabulary having the spelling “tesre”, the pronunciation “tEsrE”, and the pronunciation acquisition code “0” acquires a score of 980. The spelling “tesla” having the largest score 1000 is output as the recognition result. However, since the correct recognition result is the spelling “terse”, the correct recognition result cannot be obtained.

On the other hand, the matching process is performed without using the weighting value “0.55” and the like. The vocabulary having the spelling “tesla” acquires the second score of “450” obtained by multiplying the first score “1000” by the weighting value “0.45.” The vocabulary having the spelling “tesre” acquires the second score of “539” obtained by multiplying the first score “980” by the weighting value “0.55.” The spelling “terse” acquiring the largest score “539” is output as the recognition result. Since the correct recognition result is the spelling “terse”, the correct recognition result is obtained.

Since the pronunciation “tEsl@” and the pronunciation “tEsrE” are all different from the pronunciation “tEslE” by one phoneme, the values of the first scores thereof are equal to each other, thereby causing the erroneous recognition result. The second score compensates for the score corresponding to one phoneme erroneously generated from the pronunciation generation unit 13, thereby outputting the correct recognition result.

Next, a case in which the pronunciation “tEsl@” of the vocabulary having the spelling “tesla”, the pronunciation d2 of which can be acquired from the pronunciation dictionary unit 12, is input in voice will be described.

First, the matching process is performed without using the weighting value “0.55” and the like. It is assumed that the vocabulary having the spelling “tesla”, the pronunciation “tEsl@”, and the pronunciation acquisition code “1” acquires the score “1500.” It is also assumed that the vocabulary having the spelling “tesre”, the pronunciation “tEsrE”, and the pronunciation acquisition code “0” acquires the score “500.” The spelling “tesla” acquiring the largest score “1500” is output as the recognition result. Since the correct recognition result is the spelling “tesla”, the correct recognition result is obtained.

On the other hand, the matching process is performed using the weighting value “0.55” and the like. The vocabulary having the spelling “tesla” acquires the second score “675” obtained by multiplying the first score “1500” by the weighting value “0.45.”. The vocabulary having the spelling “tesre” acquires the second score “275” obtained by multiplying the first score “500” by the weighting value “0.55.” The spelling “tesla” acquiring the largest score “675” is output as the recognition result. Since the correct recognition result is the spelling “tesla”, the correct recognition result is obtained.

Since the pronunciation “tEsl@” has the same phone sequence as the pronunciation “tEsl@”, it acquires the higher score. Since the pronunciation “tEsrE” is different from the pronunciation “tEsl@” by two phonemes, it acquires the lower score. In the second score, since the weighting values “0.45” and “0.55.” not having such a difference to compensate for the two phonemes are multiplied by the second score, the correct recognition result is output.

In other words, by setting the vocabulary acquired from the pronunciation dictionary unit 12 to the proper weight value “0.45” and setting the vocabulary acquired from the pronunciation generation unit 13 to the proper weighting value “0.55”, it is possible to improve the recognition rate of the speech recognition.

In the first embodiment, the pronunciations of the vocabularies registered in the recognition grammar model storage unit 14 can be distinguished by the pronunciation acquisition code having a binary value of “1” indicating that the pronunciation is a pronunciation d2 acquired from the pronunciation dictionary unit 12 and “0” indicating that the pronunciation is the pronunciation d3 acquired from the pronunciation generation unit 13 using the pronunciation generation rule. The weighting value of the recognition parameter of the speech recognition can be generated in accordance with the binary value of the pronunciation acquisition code of the vocabulary in recognizing voice, thereby enhancing the performances such as the recognition rate, the amount of calculation, and the amount of used memory of the speech recognition.

According to the first embodiment, it is possible to provide the method of registering vocabularies as the speech recognition subject, recognition parameters, and the like in the recognition grammar model storage unit 14 and the speech recognition method, which can enhance the performances such as the recognition rate, the amount of calculation, and the amount of used memory of the speech recognition.

Second Embodiment

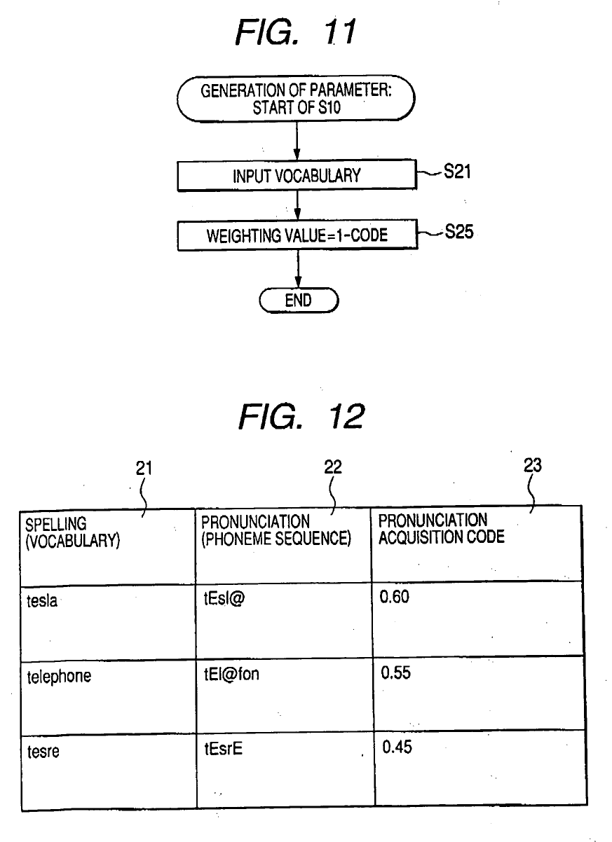

In a second embodiment, an example for using another weighting method to generate the recognition parameters in the parameter generation unit 16 in step S10 shown in FIGS. 4 to 16 will be described. FIG. 11 is a flowchart illustrating a parameter generation process of the parameter generation unit 16 of step S10.

First, similarly to the process of step S21 shown in FIG. 7, a vocabulary d1 is input to the parameter generation unit 16 from the recognition grammar model storage unit 14 shown in FIG. 1 or the like in step S21, and then the process of step S25 is performed.

In step S25, the parameter generation unit 16 sets a value obtained by subtracting the value of the pronunciation acquisition code from the value “1” as the weighting value. Then, the parameter generation process of step S10 shown in FIG. 4 and the like is terminated.

The second embodiment is different from the first embodiment in a method of setting the value of the pronunciation acquisition code.

FIG. 12 illustrates the vocabularies, the phoneme sequences, and the pronunciation acquisition codes additionally stored in the recognition grammar model storage unit 14 shown in FIG. 1 according to the second embodiment. The recognition grammar model storage unit 14 has the spelling field 21, the phoneme sequence field 22, and the pronunciation acquisition code field 23. One record includes a vocabulary (spelling) “tesla”, a pronunciation (phoneme sequence) “tEsl@”, and a pronunciation acquisition code “0.60.” Another record includes a spelling “telephone”, a pronunciation “tEl@fon”, and a pronunciation acquisition code “0.55.” Another record includes a spelling “tesre”, a pronunciation “tEsrE”, and a pronunciation acquisition code “0.45.” The spellings and the pronunciations are similar to those shown in FIG. 9 according to the first embodiment.

The pronunciation acquisition codes “0.60”, “0.55”, and “0.45” are the likelihood of the pronunciation corresponding to the vocabulary (spelling) and continuous values indicating whether the pronunciation of the vocabulary (spelling) is acquired from the pronunciation dictionary unit 12 or the pronunciation generation unit 13. The larger value of the pronunciation acquisition code means that the pronunciation is more likely. When the pronunciation is acquired from the pronunciation dictionary unit 12, a value greater than a boundary value is set, and when the pronunciation is acquired from the pronunciation generation unit 13, a value smaller than the boundary value is set. In the second embodiment, since the boundary value is set to “0.5” and the pronunciation acquisition codes 0.60 and 0.55 of the pronunciation “tEsl@” and the pronunciation “tEl@fon” are greater than the boundary value 0.5, the pronunciations are the pronunciations d2 acquired from the pronunciation dictionary unit 12. Since the pronunciation acquisition code 0.45 of the pronunciation “tEsrE” is smaller than the boundary value 0.5, the pronunciation is the pronunciation d3 acquired from the pronunciation generation unit 13. The boundary value 0.5 is only one example, and it may be other values only if they can distinguish whether the pronunciation is acquired from the pronunciation dictionary unit 12 or the pronunciation is acquired from the pronunciation generation unit 13.

The pronunciation dictionary unit 12 correlates and stores the spellings and the pronunciations with each other and transmits the pronunciation d2 corresponding to the spelling d1 in response to the request from the recognition grammar model generation unit 11. The pronunciation dictionary unit 12 correlates and stores the spelling, the pronunciation, and the continuous value indicating the likelihood of the pronunciation and transmits the pronunciation corresponding to the spelling d1 and the continuous value indicating the likelihood of the pronunciation to the recognition grammar model generation unit 11 in response to the request from the recognition grammar model generation unit 11. As for the continuous value indicating the likelihood of the pronunciation, the continuous value indicating the likelihood of a word having a difference in pronunciation between talkers such as “often” in English may be lowered, or the continuous value indicating the likelihood of a word having a difference in pronunciation between locals such as “herb” in English may be lowered.

An example of the pronunciation dictionary unit 12 is that a pronunciation is correlated and stored with a score, which is disclosed in Japanese Patent No. 3476008 (corresponding US application is: U.S. Pat. No. 6,952,675 B1).

The pronunciation generation unit 13 generates a pronunciation from a character sequence of a spelling by the use of the phoneme sequence of a pronunciation and a conversion rule. The pronunciation generation unit 13 generates a pronunciation and a value of the likelihood of the pronunciation from the character sequence of the spelling by the use of the phoneme sequence of the pronunciation and the conversion rule for conversion into the value indicating the likelihood of the pronunciation. The likelihood of the pronunciation can be set as follows. The probabilities to which the rules can be applied are added as the scores to the rules for converting the spelling characters to the phoneme sequences of pronunciations. The rules are sequentially applied to the characters of the spelling and the scores of the applied rules are integrated. The score of the pronunciation having the highest score can be used as the value indicating the likelihoodof the pronunciation. It is preferable that the value indicating the likelihood of the pronunciation is set to a value smaller than the boundary value through a normalization process.

An example of the pronunciation generation unit 13 is that a pronunciation is generated along with a score, which is disclosed in Japanese Patent No. 3481497 (corresponding EP Application is: EP 0953970 B1).

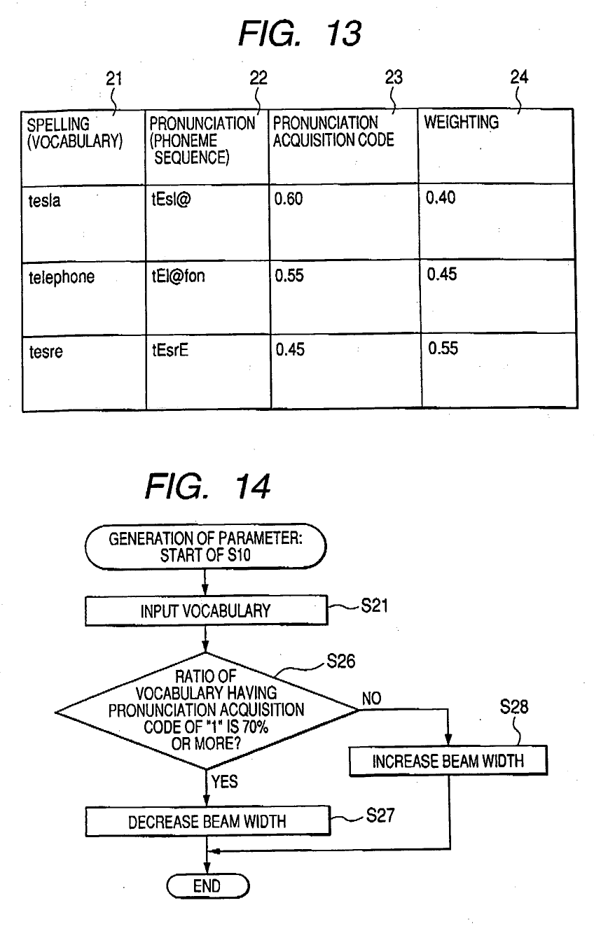

FIG. 13 illustrates the recognition grammar model storage unit 14 according to the second embodiment in which a weighting value as a recognition parameter d6 generated from the parameter generation unit 16 shown in FIG. 1 is correlated and stored with a vocabulary d1, a phoneme sequence, and a pronunciation acquisition code. The recognition grammar model storage unit 14 has a weighting field 24, in addition to the spelling field 21, the phoneme sequence field 22, and the pronunciation acquisition field 23. A weighting value is correlated with a record including a spelling, a pronunciation, and a pronunciation acquisition code. The weighting value is generated and stored when the record including a spelling, a pronunciation, and a pronunciation acquisition code is processed through the parameter generation process shown in FIG. 11. One record including the spelling “tesla”, the pronunciation “tEsl@”, and the pronunciation acquisition code “0.60” is correlated with a weighting value “0.40.” Another record including the spelling “telephone”, the pronunciation “tEl@fon”, and the pronunciation acquisition code “0.55” is correlated with a weighting value “0.45.” Another record including the spelling “tesre”, the pronunciation “tEsrE”, and the pronunciation acquisition code “0.45” is correlated with a weighting value “0.55.”

In the second embodiment, it is possible to properly set a weighting value of a vocabulary through the processes of the flowchart shown in FIG. 11, by setting a value indicating the likelihood of a pronunciation as a pronunciation acquisition code in each vocabulary, in addition to the first embodiment, thereby enhancing the recognition rate of the speech recognition.

Third Embodiment

In a third embodiment, an example in which a beam width as a recognition parameter other than the weighting value is generated at the time of generating the recognition parameter in the parameter generation unit 16 of step S10 shown in FIGS. 4 to 6 will be described. FIG. 14 is a flowchart illustrating a parameter generation process of the parameter generation unit 16 of step S10 according to the third embodiment.

First, similarly to the process of step S21 in FIG. 7, in step S21, the vocabulary d1 is input to the parameter generation unit 16 from the recognition grammar model storage unit 14 in FIG. 1 or the like, and then the process of step S26 is performed. As shown in FIG. 9, the pronunciation acquisition code of the vocabulary input from the recognition grammar model storage unit 14 is a code expressing in binary values of “1” and “0” whether the pronunciation corresponding to the vocabulary (spelling) is acquired from the pronunciation dictionary unit 12 or the pronunciation generation unit 13. The pronunciation acquisition code is set to “1” when the pronunciation is acquired from the pronunciation dictionary unit 12 and is set to “0” when the pronunciation is acquired from the pronunciation generation unit 13.

In step S26, the parameter generation unit 16 determines whether the ratio of the vocabularies having the pronunciation acquisition code of “1” to the vocabularies registered in the recognition grammar model storage unit 14 is 70% or more. When the ratio of the vocabularies having the pronunciation acquisition code of “1” to the vocabularies registered in the recognition grammar model storage unit 14 is 70% or more, that is, when the ratio of the vocabularies of which the pronunciations are acquired from the pronunciation dictionary unit 12 is 70% or more, the process of step S27 is performed. When the ratio of the vocabularies having the pronunciation acquisition code of “1” to the vocabularies registered in the recognition grammar model storage unit 14 is less than 70%, that is, when the ratio of the vocabularies of which the pronunciations are acquired from the pronunciation generation unit 13 is more than 30%, the process of step S28 is performed.

In step S27, the parameter generation unit 16 reduces the beam width of a beam search process in the matching unit 19, and then the parameter generation process of step S10 in FIG. 4 or the like is terminated.

In step S28, the parameter generation unit 16 widens the beam width of the beam search process in the matching unit 19, and the parameter generation process of step S10 in FIG. 4 is terminated.

70% as the ratio of the vocabularies of which the pronunciation acquisition codes are “1” in step S26 is only one example, and the ratio may be properly set so as to enhance the performances such as the recognition rates, the amount of calculation, and the amount of used memory in accordance with the increase and decrease of the beam width. The beam width may be step by step in accordance with the ratio of the vocabularies of which the pronunciations are acquired from the pronunciation dictionary unit 12 and the vocabularies of which the pronunciations are acquired from the pronunciation generation unit 13.

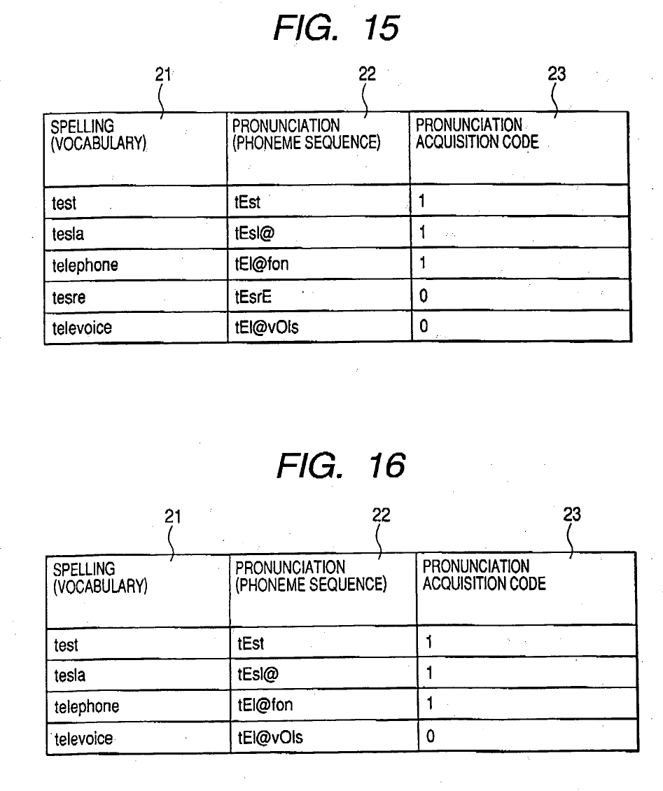

FIG. 15 illustrates examples of the vocabularies, the phoneme sequences, and the pronunciation acquisition codes stored in the recognition grammar model storage unit 14 shown in FIG. 1 according to the third embodiment. The recognition grammar model storage unit 14 has a spelling field 21, a phoneme sequence field 22, and a pronunciation acquisition code field 23. One record includes a vocabulary (spelling) “test”, a pronunciation (phoneme sequence) “tEst”, and a pronunciation acquisition code “1.” Another record includes a vocabulary (spelling) “tesla”, a pronunciation (phoneme sequence) “tEsl@”, and a pronunciation acquisition code “1.” Another record includes a spelling “telephone”, a pronunciation “tEl@fon”, and a pronunciation acquisition code “1.” Another record includes a spelling “tesre”, a pronunciation “tEsrE”, and a pronunciation acquisition code “0.” Another record includes a spelling “televoice”, a pronunciation “tEl@vOIs”, and a pronunciation acquisition code “0.” The spellings “test”, “tesla”, “telephone”, “terse”, and “televoice correspond to the vocabularies (spellings) d1 input to the recognition grammar model generation unit 11 shown in FIG. 1. The pronunciations “tEst”, “tEsl@”, “tEl@fon”, “tEsrE”, and “tEl@vOIs” are the pronunciations d2 and d3 corresponding to the spellings d1 acquired from the pronunciation dictionary unit 12 or the pronunciation generation unit 13 shown in FIG. 1, and are expressed by the continuous phonemes defining each sound. The pronunciation acquisition codes “1”, “1”, “1”, “0”, and “0” are codes expressing in binary values whether the pronunciations d2 and d3 corresponding to the vocabularies (spellings) d1 are acquired from the pronunciation dictionary unit 12 or the pronunciation generation unit 13. When the pronunciation d2 is acquired from the pronunciation dictionary unit 12, the pronunciation acquisition code is set to “1”, and when the pronunciation d3 is acquired from the pronunciation generation unit 13, the pronunciation acquisition code is set to “0.” From the above-mentioned description, it can be seen that the pronunciation “tEst” of the vocabulary “test” is acquired from the pronunciation dictionary unit 12. It can be seen that the pronunciation “tEsl@” of the vocabulary “tesla” is acquired from the pronunciation dictionary unit 12. It can be also seen that the pronunciation “tEl@fon” of the spelling “telephone” is acquired from the pronunciation dictionary unit 12. It can be also seen that the pronunciation “tEsrE” of the spelling “terse” is acquired from the pronunciation generation unit 13. It can be seen that the pronunciation “tEl@vOIs” of the vocabulary “televoice” is acquired from the pronunciation generation unit 13.

FIG. 16 illustrates examples of the vocabularies, the phoneme sequences, and the pronunciation acquisition codes stored in the recognition grammar model storage unit 14 shown in FIG. 1 according to the third embodiment. The recognition grammar model storage unit 14 has a spelling field 21, a phoneme sequence field 22, and a pronunciation acquisition code field 23. One record includes a vocabulary (spelling) “test”, a pronunciation (phoneme sequence) “tEst”, and a pronunciation acquisition code “1.” Another record includes a vocabulary (spelling) “tesla”, a pronunciation (phoneme sequence) “tEsl@”, and a pronunciation acquisition code “1.” Another record includes a spelling “telephone”, a pronunciation “tEl@fon”, and a pronunciation acquisition code “1.” Another record includes a spelling “televoice”, a pronunciation “tEl@vOIs”, and a pronunciation acquisition code “0.”

The matching unit 19 can acquire the correct recognition result of a voice with a higher probability as the beam width in the beam search is greater, and can acquire the recognition result with a smaller amount of calculation and a smaller amount of used memory as the beam width in the beam search. The beam search is a method of accumulating the appearance probability of the time-series feature parameter output from the feature generation unit 18 for the acoustic model of the vocabulary every frame of the input feature parameter, storing only an assumption having a score within a threshold value (beam) from the highest score on the basis of an assumption having the highest score as the accumulated value, and deleting other hypotheses because they are not used. The assumption means a temporary recognition result assumed in the course of searching out the recognition result of a voice. When the beam width in the beam search is widened, the process of searching many hypotheses for the recognition result is performed. Accordingly, the probability that the correct recognition result is included in the assumption is increased, thereby increasing the possibility for obtaining the correct recognition result. When the beam width in the beam search is narrowed, the probability of deleting the correct recognition result in the course of searching the assumption for the recognition result is increased, thereby increasing the possibility for obtaining the correct recognition result. When the beam width in the beam search is widened, the process of searching many hypotheses for the recognition result should be performed and thus the amount of calculation and the amount of used memory are increased. When the beam width in the beam search is narrowed, the number of hypotheses from which the recognition result is searched out is decreased and thus the amount of calculation and the amount of used memory are decreased. The beam search may be performed in various methods. For example, a method of keeping the number of hypotheses constant and deleting the assumption having a low score is known.

Another example of the beam search is disclosed in Japanese Patent No. 3346285.

The pronunciation d2 acquired from the pronunciation dictionary unit 12 is a pronunciation registered in advance in the pronunciation dictionary unit 12 and the accuracy of the registered pronunciation d2 is reliable. The pronunciation d3 acquired from the pronunciation generation unit 13 is a pronunciation generated using the pronunciation generation rule and the accuracy of the pronunciation generated using the rule is lower than that of the pronunciation registered in the pronunciation dictionary unit 12. That is, the pronunciation d3 acquired from the pronunciation generation unit 13 may be partially incorrect.

When the matching process of step S11 shown in FIG. 6 is performed in this way, a talker pronounces a correct pronunciation but an incorrect pronunciation is registered in the recognition grammar model storage unit 14 and is used in the matching process, thereby not obtaining a correct recognition result. In other words, the vocabulary having the partially incorrect pronunciation d3 acquired from the pronunciation generation unit 13 may be deleted at the partially incorrect position of the pronunciation from the assumption in the course of the beam search and thus may not be acquired as the recognition result.

Accordingly, in the third embodiment, when the ratio of the vocabulary d1 having the pronunciation d2 acquired from the pronunciation dictionary unit 12 is less than a predetermined value, that is, when the ratio of the vocabulary d1 having the pronunciation d3 acquired from the pronunciation generation unit 13 is more than a predetermined value, the parameter generation unit 16 widens the beam width in the beam search, thereby not deleting the vocabulary d1 of which the pronunciation d3 is acquired from the pronunciation generation unit 13 from the assumption. Accordingly, it is possible to enhance the recognition rate of the speech recognition.

When the ratio of the vocabulary d1 having the pronunciation acquired from the pronunciation dictionary unit 12 is no less than a predetermined value, that is, when the ratio of the vocabulary d1 having the pronunciation acquired from the pronunciation generation unit 13 is less than a predetermined value, the parameter generation unit 16 narrows the beam width in the beam search, thereby decreasing the mount of calculation and the amount of used memory of the speech recognition in the matching unit 19. When the ratio of the vocabulary d1 having the pronunciation d3 acquired from the pronunciation dictionary unit 13 is less than a predetermined value, the beam width in the beam search is relatively narrowed in comparison with the case where the ratio of the vocabulary d1 having the pronunciation d3 acquired from the pronunciation generation unit 13 is no less than a predetermined value because the ratio of the vocabularies having the correct pronunciation d2 is relatively great. Accordingly, the possibility for deleting the correct recognition result from the assumption with decrease in beam width, and thus the influence on the recognition rate of the speech recognition is small. Instead, the amount of calculation and the amount of used memory of the speech recognition can be decreased.

For example, it is assumed that the vocabularies having the spellings, the pronunciations, and the pronunciation acquisition codes shown in FIG. 15 are registered in the recognition grammar model storage unit 14. It is also assumed that the correct pronunciation of the spelling “tesre” is “tEslE.” Since the ratio of the vocabulary having the pronunciation d2 acquired from the pronunciation dictionary unit 12 is 60% which is ⅗, the process of step S28 in FIG. 14 is performed, where the parameter generation unit 16 widens the beam width.

The matching process using the beam search is performed to the pronunciation “tEslE” of the voice input d11 by the matching unit 19. In the step of processing “1” which is the fourth phoneme of the pronunciation “tEslE”, the vocabulary most similar to the pronunciation is a vocabulary having the spelling “tesre” and the pronunciation “tEsl@.” The vocabulary having the spelling “tesre” and the pronunciation “tEsrE” as the correct recognition result is not the vocabulary most similar to the pronunciation, since the fourth phoneme of the pronunciation “tEsrE” is “r” which is incorrect. Since the beam width is widened by the parameter generation unit 16 and many vocabularies are left in the hypotheses, the vocabulary having the spelling “tesre” and the pronunciation “tEsrE” as the correct recognition result is left in the hypotheses. The vocabulary having the spelling “tesre” and the pronunciation “tEsrE” as the vocabulary most similar to the input pronunciation is acquired as the recognition result, by processing the final phoneme of the pronunciation “tEslE.”

In this way, by setting a proper beam width in accordance with the ratio in number of the pronunciations d2 acquired from the pronunciation dictionary unit 12 and the pronunciations d3 acquired from the pronunciation generation unit 13, the vocabularies having the partially incorrect pronunciations d3 acquired from the pronunciation generation unit 13 can be left in recognition candidates as the assumption, thereby enhancing the recognition rate of the speech recognition.

In addition, it is assumed that the vocabularies having the spellings, the pronunciations, and the pronunciation acquisition codes shown in FIG. 15 are registered in the recognition grammar model storage unit 14. Since the ratio of the vocabulary having the pronunciation d2 acquired from the pronunciation dictionary unit 12 is 75% which is ¾, the process of step S27 in FIG. 14 is performed, where the parameter generation unit 16 narrows the beam width.

The matching process using the beam search is performed to the pronunciation “tEslE” of the voice input d11 by the matching unit 19. Since the number of vocabularies left in the assumption is small by allowing the parameter generation unit 16 to narrow the beam width but the vocabulary having a pronunciation similar to the pronunciation “tEsl@” is only the vocabulary having the spelling “tesla”, the vocabulary having the spelling “tesla” is acquired as the recognition result.

In this way, by setting a proper beam width in accordance with the ratio in number of the pronunciations d2 acquired from the pronunciation dictionary unit 12 and the pronunciations d3 acquired from the pronunciation generation unit 13, it is possible to decrease the number of processes of searching many unnecessary hypotheses with the recognition rate of the speech recognition maintained, thereby decreasing the amount of calculation and the amount of used memory of the speech recognition.

In brief, when the ratio in number of the vocabularies d1 having the pronunciation d3 acquired from the pronunciation generation unit 13 is great, the possibility that the vocabularies d1 having the partially incorrect pronunciation d3 is registered in the recognition grammar model storage unit 14 is high. In this case, by setting the beam width in the beam search wide, it is possible to prevent the vocabularies from being deleted at the incorrect positions of the pronunciation d3 of the vocabularies d1 from the assumption and thus to acquire the correct recognition result as the recognition result most similar to the pronunciation among the pronunciations d3, thereby enhancing the recognition rate of the speech recognition. When the ratio in number of the vocabularies d1 having the pronunciation d2 acquired from the pronunciation dictionary unit 12 is great, the possibility that the vocabularies having the correct pronunciation are registered in the recognition grammar model storage unit 14. In this case, although the beam width in the beam search is set narrow, the possibility for deleting the correct recognition result from the assumption is low, thereby acquiring the correct recognition result. In addition, by narrowing the beam width in the beam search, it is possible to decrease the amount of calculation and the amount of used memory of the speech recognition. The method of setting the beam width in the beam search may be combined with a method of setting the beam width such as increasing or decreasing the beam width in accordance with the number of vocabularies registered in the recognition grammar model storage unit 14.

Fourth Embodiment

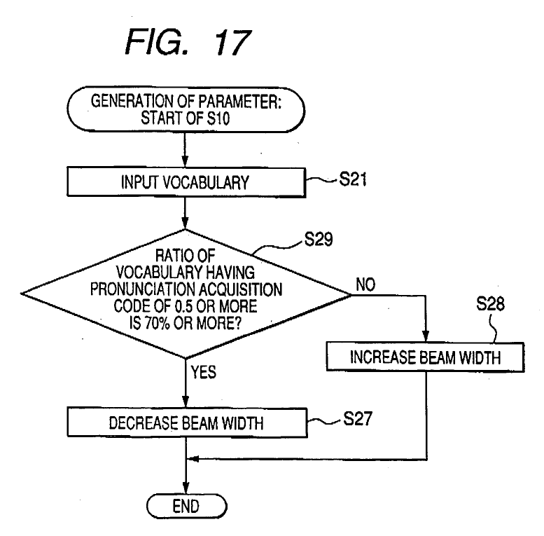

In a fourth embodiment 4, an example of generating a beam width different from that of the third embodiment when the parameter generation unit 16 generates the recognition parameter in step S10 shown in FIGS. 4 to 6 will be described. FIG. 17 is a flowchart illustrating a parameter generation process of the parameter generation unit 16 in step S10 according to the fourth embodiment.

First, similarly to the process of step S21 of FIG. 7, in step S21, a vocabulary d1 is input to the parameter generation unit 16 from the recognition grammar model storage unit 14 shown in FIG. 1 and then the process of step S29 of FIG. 17 is performed. The pronunciation acquisition code of the fourth embodiment is similar to the pronunciation acquisition code of the second embodiment. That is, the pronunciation acquisition code input to the parameter generation unit 16 from the recognition grammar model storage unit 14 is a continuous value indicating the likelihood of a pronunciation corresponding to a vocabulary (spelling) and indicating whether the pronunciation corresponding to the vocabulary (spelling) is acquired from the pronunciation dictionary unit 12 or the pronunciation generation unit 13, as shown in FIG. 12. The greater value of the pronunciation acquisition code indicates the more likelihood of the pronunciation. The pronunciation acquisition code is set to a value greater than a boundary value, for example, “0.5”, when the pronunciation is acquired from the pronunciation dictionary code 12 and is set to a value less than the boundary value, for example, “0.5”, when the pronunciation is acquired from the pronunciation generation unit 13. Although the boundary value is 0.5 in FIG. 5, the boundary value may be set to any value only if it is constant in the second embodiment and the fourth embodiment.

The parameter generation unit 16 determines in step S29 of FIG. 17 whether the ratio in number of the vocabularies of which the pronunciation acquisition code is greater than the boundary value “0.5” among the vocabularies registered in the recognition grammar model storage unit 14 is 70% or more. When the ratio in number of the vocabularies of which the pronunciation acquisition code is greater than the boundary value “0.5” among the vocabularies registered in the recognition grammar model storage unit 14 is 70% or more, that is, when the ratio in number of the vocabularies of which the pronunciation is acquired from the pronunciation dictionary unit 12 is 70% or more, the process of step S27 is performed. When the ratio in number of the vocabularies of which the pronunciation acquisition code is greater than the boundary value “0.5” is less than 70%, that is, when the ratio in number of the vocabularies of which the pronunciation is acquired from the pronunciation generation unit 13 is 30% or more, the process of step S28 is performed.

In step S27, the parameter generation unit 16 narrows the beam width in the beam search of the matching unit 19 and the parameter generation process of step S10 in FIG. 4 or the like is terminated.

In step S28, the parameter generation unit 16 widens the beam width in the beam search of the matching unit 19 and the parameter generation process of step S10 in FIG. 4 or the like is terminated.

The value of 70%, which is the ratio in number of the vocabularies of which the pronunciation acquisition code is greater than the boundary value “0.5” in step S26, is only an example and the ratio may be properly set so as to enhance the performances such as the recognition rate, the amount of calculation, and the amount of used memory of the speech recognition with the increase and decrease of the beam width. A plurality of beam widths may be set gradually in accordance with the ratio of the vocabularies of which the pronunciation is acquired from the pronunciation dictionary unit 12 and the vocabularies of which the pronunciation is acquired from the pronunciation generation unit 13.

In the fourth embodiment, it can be confirmed by the pronunciation acquisition code having a continuous value whether the pronunciation of the vocabulary registered in the recognition grammar model storage unit 14 is the pronunciation d2 acquired from the pronunciation dictionary unit 12 or the pronunciation d3 acquired from the pronunciation generation unit 13 using the pronunciation generation rule. In addition, the likelihood of the pronunciation of the vocabulary can be confirmed by the pronunciation acquisition code having a continuous value. Accordingly, it is possible to enhance the performance such as the recognition rate of the speech recognition in the matching unit 19 by generating the beam width which is a recognition parameter of the speech recognition at the time of recognizing a voice.

According to the fourth embodiment, similarly to the third embodiment, it is possible to provide the method of registering vocabularies as the speech recognition subject in the recognition grammar model and the speech recognition method, which can enhance the performances such as the recognition rate, the amount of calculation, and the amount of used memory of the speech recognition.

The first to fourth embodiments are specific examples for putting the invention into practice, and the first to fourth embodiments should not limit the technical scope of the invention. That is, although the examples of making it easier to extract the vocabularies having the generated pronunciation have been described in the first to fourth embodiments, it may be also considered that the vocabularies having a pronunciation acquired from a dictionary are more easily extracted than the vocabularies having the generated pronunciation depending upon the situation where the speech recognition system is used. Accordingly, which to make it easier to extract may be set depending upon the situation. In other words, in the situation where the speech recognition system is used, this is because the degree of importance may be reversed between a vocabulary having an accurate pronunciation (a command such as “Display a map” or a initially registered place name in a car navigation system or the like) and a vocabulary having an inaccurate pronunciation (a place name registered later by a user in the car navigation system or the like).

Thepresent invention maybemodified invarious forms without departing from the technical spirit and the important features of the invention. That is, the invention may be changed, improved, or partially utilized without departing from the scope of the appended claims, and all of them are included in the claims of the present invention.

What is claimed is:

1. A speech recognition system comprising:
an A/D converter that generates voice data by quantizing a voice signal that is obtained by recording a speech;
a feature generation unit that generates a feature parameter of the voice data based on the voice data;
an acoustic model storage unit that stores acoustic models for each of phonemes as an acoustic feature parameter, the phonemes being included in a language spoken in the speech;
a matching unit that expresses pronunciations of a plurality of vocabularies spoken in the speech by time series of phonemes as phoneme sequence, calculates a degree of similarity of the phoneme sequence to the feature parameter as a score, and outputs a vocabulary corresponding to the phoneme sequence having the highest score as the vocabulary corresponding to the voice signal;
a pronunciation dictionary unit that stores the vocabularies being correlated with the phoneme sequences;
a pronunciation generation unit that generates the phoneme sequence of the vocabulary input from the matching unit;
a recognition grammar model generation unit that,
when the input vocabulary is stored in the pronunciation dictionary unit, acquires the phoneme sequence correlated with the vocabulary from the pronunciation dictionary unit and generates a dictionary code indicating that the acquisition source is the pronunciation dictionary unit, and
when the input vocabulary is not stored in the pronunciation dictionary unit, acquires the phoneme sequence correlated with the input vocabulary from 10 the pronunciation generation unit and generates a generation code indicating that the acquisition source is the pronunciation generation unit;
a recognition grammar model storage unit that stores a recognition grammar model in which the vocabulary input from the matching unit, the phoneme sequence corresponding to the input vocabulary, and one of the dictionary code and the generation code of the input vocabulary, are correlated with each other; and
a parameter generation unit that generates a recognition parameter.

2. The speech recognition system according to claim 1, wherein the parameter generation unit generates the recognition parameter including a weighting value, and
wherein the matching unit calculates the score of an integrated value of the weighing value and an accumulated value.

3. The speech recognition system according to claim 1, wherein the parameter generation unit generates the recognition parameter including a beam width used in a beam search for extracting acoustic models of the vocabulary correlated with the generation code from acoustic models stored in the acoustic model storage unit.

4. A recognition grammar model generation device for outputting a recognition grammar model to a speech recognition device, the recognition grammar model generation device comprising:
a pronunciation dictionary unit that stores vocabularies being correlated with phoneme sequences, the phoneme sequences expressing pronunciations of a plurality of vocabularies spoken in a speech by time series of phonemes, the speech being subjected to a speech recognition in the speech recognition device;
a pronunciation generation unit that generates the phoneme sequence of the vocabulary input from the speech recognition device;
a recognition grammar model generation unit that,
when the input vocabulary is stored in the pronunciation dictionary unit, acquires the phoneme sequence correlated with the vocabulary from the pronunciation dictionary unit and generates a dictionary code indicating that the acquisition source is the pronunciation dictionary unit, and
when the input vocabulary is not stored in the pronunciation dictionary unit, acquires the phoneme sequence correlated with the input vocabulary from the pronunciation generation unit and generates a generation code indicating that the acquisition source is the pronunciation generation unit;
a recognition grammar model storage unit that stores a recognition grammar model in which the vocabulary input from the speech recognition device, the phoneme sequence corresponding to the input vocabulary, and one of the dictionary code and the generation code of the input vocabulary, are correlated with each other; and
a parameter generation unit that generates a recognition parameter.

5. The recognition grammar model generation device according to claim 4, wherein the parameter generation unit generates the recognition parameter including a weighting value.

6. The recognition grammar model generation device according to claim 4, wherein the parameter generation unit generates the recognition parameter including a beam width used in a beam search for extracting acoustic models of the vocabulary correlated with the generation code from acoustic models stored in the speech recognition device.

7. A method for generating a recognition grammar model used in a speech recognition device, the method comprising:
storing in a pronunciation dictionary unit vocabularies being correlated with phoneme sequences, the phoneme sequences expressing pronunciations of a plurality of vocabularies spoken in a speech by time series of phonemes, the speech being subjected to a speech recognition in the speech recognition device;
generating by a pronunciation generation unit the phoneme sequence of the vocabulary input from the speech recognition device;
acquiring the phoneme sequence correlated with the vocabulary from the pronunciation dictionary unit and generating a dictionary code indicating that the acquisition source is the pronunciation dictionary unit, when the input vocabulary is stored in the pronunciation dictionary unit;
acquiring the phoneme sequence correlated with the input vocabulary from the pronunciation generation unit and generating a generation code indicating that the acquisition source is the pronunciation generation unit, when the input vocabulary is not stored in the pronunciation dictionary unit;
storing a recognition grammar model in which the vocabulary input from the speech recognition device, the phoneme sequence corresponding to the input vocabulary, and one of the dictionary code and the generation code of the input vocabulary, are correlated with each other; and
generating a recognition parameter.

8. The method according to claim 7, wherein the recognition parameter includes a weighting value.

9. The method according to claim 7, wherein the recognition parameter includes a beam width used in a beam search for extracting acoustic models of the vocabulary correlated with the generation code from acoustic models stored in the speech recognition device.

10. A speech recognition device comprising:
an A/D converter that generates voice data by quantizing a voice signal that is obtained by recording a speech;
a feature generation unit that generates a feature parameter of the voice data based on the voice data;
an acoustic model storage unit that stores acoustic models for each of phonemes as an acoustic feature parameter, the phonemes being included in a language spoken in the speech; and
a matching unit that expresses pronunciations of a plurality of vocabularies spoken in the speech by time series of phonemes as phoneme sequence, calculates a degree of similarity of the phoneme sequence to the feature parameter as a score, and outputs a vocabulary corresponding to the phoneme sequence having the highest score as the vocabulary corresponding to the voice signal.

11. The speech recognition device according to claim 10, wherein the matching unit calculates the score of an integrated value of the weighing value and an accumulated value.
